(19) United States
(12) Patent Application Publication
(10) Pub. No.: US 2021/0159540 A1
(43) Pub. Date: May 27, 2021

(54) NONAQUEOUS ELECTROLYTE SECONDARY BATTERY

(71) Applicant: MURATA MANUFACTURING CO., LTD., Kyoto (JP)

(72) Inventor: Takuju HASHIMOTO, Kyoto (JP)

(21) Appl. No.: 17/168,795

(22) Filed: Feb. 5, 2021

Related U.S. Application Data
(63) Continuation of application No. PCT/JP2019/033302, filed on Aug. 26, 2019.

(30) Foreign Application Priority Data
Aug. 24, 2018 (JP) 2018-157037

(51) Int. Cl. H01M 10/0567; H01M 10/0525; H01M 10/0569; H01M 4/66; H01M 4/70; H01M 50/491; H01M 4/04; H01M 4/62; H01M 10/0568

(52) U.S. Cl. CPC H01M 10/0567; H01M 10/0525; H01M 10/0569; H01M 4/662; H01M 4/669; H01M 2004/028; H01M 50/491; H01M 4/0404; H01M 4/623; H01M 10/0568; H01M 4/70

(57) ABSTRACT

Provided is a nonaqueous electrolyte secondary battery including a positive electrode, a negative electrode, and an electrolytic solution. The positive electrode has a positive active material layer including a fluorine-based binder having a melting point of 166° C. or lower, a content of the fluorine-based binder in the positive active material layer is from 0.5 mass % to 2.8 mass %, the electrolytic solution includes at least a first additive selected from 1,3-dioxane and a 1,3-dioxane derivative thereof, and a content of the first additive in the electrolytic solution is from 0.1 mass % to 2 mass %.

### CROSS REFERENCE TO RELATED APPLICATIONS

The present application is a continuation of PCT patent application no. PCT/JP2019/033302, filed on Aug. 26, 2019, which claims priority to Japanese patent application no. JP2018-157037 filed on Aug. 24, 2018, the entire contents of which are being incorporated herein by reference.

### BACKGROUND

The present technology generally relates to a nonaqueous electrolyte secondary battery.

Nonaqueous electrolyte secondary batteries are widely used as power sources for mobile phones, notebook computers, power tools, electric vehicles and the like because they are lightweight and have a high energy density. Since the characteristics of a nonaqueous electrolyte secondary battery are considerably affected by a nonaqueous electrolytic solution used, various additives to be added to the nonaqueous electrolytic solution have been proposed.

### SUMMARY

The present technology generally relates to a nonaqueous electrolyte secondary battery.

In recent years, nonaqueous electrolyte secondary batteries have come to be used in various environments, and therefore a technique has been strongly desired which enables a high discharge capacity and good charge-discharge cycle characteristics to be obtained even in a low-temperature environment and a high-temperature environment.

An object of the present technology is to provide a nonaqueous electrolyte secondary battery capable of attaining a high discharge capacity in a low temperature environment and good charge-discharge cycle characteristics even in a high temperature environment.

For solving the above-described problems, a nonaqueous electrolyte secondary battery is provided according to an embodiment of the present disclosure. The nonaqueous electrolyte secondary battery includes a positive electrode, a negative electrode, and an electrolytic solution. The positive electrode has a positive active material layer including a fluorine-based binder having a melting point of 166° C. or lower, a content of the fluorine-based binder in the positive active material layer is from 0.5 mass % to 2.8 mass %, the electrolytic solution includes at least a first additive selected from 1,3-dioxane and a 1,3-dioxane derivative thereof, and a content of the first additive in the electrolytic solution is from 0.1 mass % to 2 mass %.

According to the present technology, it is possible to obtain a high discharge capacity in a low temperature environment, and it is possible to obtain good charge-discharge cycle characteristics even in a high temperature environment.

It should be understood that the effects described here are not necessarily limited and may be any one of the effects described in the present invention or an effect different from them.

### BRIEF DESCRIPTION OF THE FIGURES

FIG. 1 is an exploded perspective view showing an example of a configuration of a nonaqueous electrolyte secondary battery according to an embodiment of the present technology.

FIG. 2 is a sectional view taken along line II-II of FIG. 1.

FIG. 3 is a graph showing an example of a DSC curve of a fluorine-based binder according to an embodiment of the present disclosure.

FIG. 4 is a block diagram showing an example of a configuration of an electronic device according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

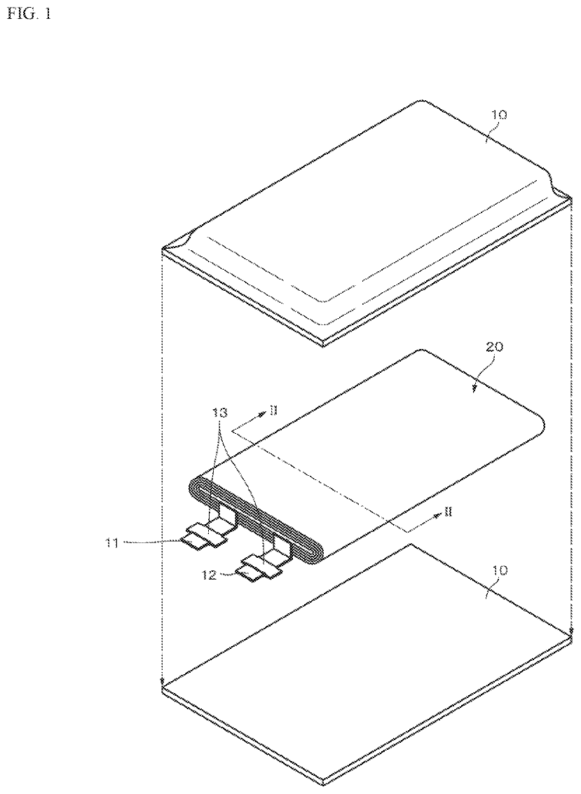

FIG. 1 shows an example of a configuration of a nonaqueous electrolyte secondary battery (hereinafter, simply referred to as a “battery”) according to a first embodiment of the present technology. The battery is a so-called laminated battery, in which an electrode body 20 provided with a positive electrode lead 11 and a negative electrode lead 12 is housed in a film-shaped exterior material 10, so that the battery can be downsized, made lighter in weight, and thinned.

The positive electrode lead 11 and the negative electrode lead 12 are led out, for example in the same direction, from the inside of the exterior material 10 to the outside. The positive electrode lead 11 and the negative electrode lead 12 are each formed of a metallic material such as Al, Cu, Ni or stainless steel, and each have a thin plate shape or a netlike shape.

The exterior material 10 is formed of, for example, a rectangular aluminum laminate film in which a nylon film, an aluminum foil and a polyethylene film are bonded in this order. The exterior material 10 is disposed in such a manner that the polyethylene film and the electrode body 20 face each other, and the outer edge portions thereof are brought into close contact with each other by welding or with an adhesive. An adhesion film 13 for preventing ingress of outside air is inserted between the exterior material 10 and the positive electrode lead 11 and negative electrode lead 12. The adhesion film 13 is formed of a material having adhesion to the positive electrode lead 11 and the negative electrode lead 12, for example a polyolefin resin such as polyethylene, polypropylene, modified polyethylene or modified polypropylene.

Instead of the above-described aluminum laminate film, a laminate film having another structure, a polymer film of polypropylene or the like, or a metal film may form the exterior material 10. Alternatively, the exterior material may be formed of a laminate film in which a polymer film is laminated on one surface or both surfaces of an aluminum film used as a core material.

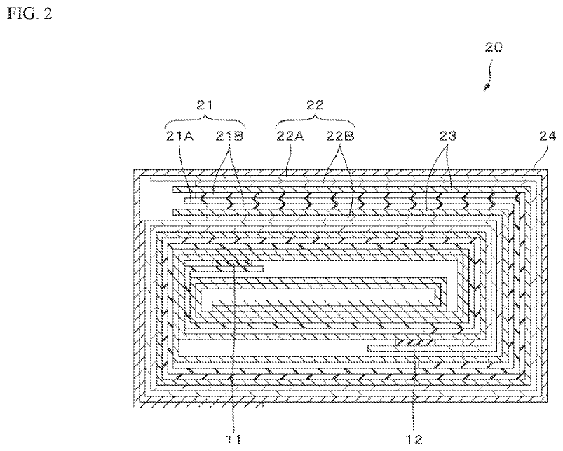

FIG. 2 is a sectional view taken along line II-II of the electrode body 20 shown in FIG. 1. The electrode body 20 is a winding-type electrode body having a configuration in which a long positive electrode 21 and negative electrode 22 are laminated with a long separator 23 interposed therebetween, and the laminate is wound in a flat shape and a spiral shape. The outermost peripheral portion is protected with a protective tape 24. An electrolytic solution as an electrolyte is injected into the exterior material 10 to impregnate the positive electrode 21, the negative electrode 22, and the separator 23.

Hereinafter, the positive electrode 21, the negative electrode 22, the separator 23, and the electrolytic solution forming the battery will be described in order.

The positive electrode 21 includes a positive electrode current collector 21A, and a positive active material layer 21B provided on both surfaces of the positive electrode current collector 21A. The positive electrode current collector 21A is formed of, for example, a metal foil such as an aluminum foil, a nickel foil or a stainless steel foil. The positive active material layer 21B contains a positive active material and a binder. The positive active material layer 21B may further contain a conductive agent if necessary.

As a positive active material capable of absorbing and releasing lithium, for example, a lithium-containing compound such as lithium oxide, lithium phosphorus oxide, lithium sulfide or an interlayer compound containing lithium is suitable. Two or more thereof may be mixed. For increasing the energy density, a lithium-containing compound containing lithium, a transition metal element and oxygen is preferable. Examples of the lithium-containing compound include lithium composite oxides having a layered rock salt-type structure of formula (A), and lithium composite phosphates having an olivine-type structure of formula (B). The lithium-containing compound is more preferably one containing at least one selected from the group consisting of Co, Ni, Mn and Fe as a transition metal element. Examples of the lithium-containing compound include lithium composite oxides having a layered rock salt-type structure of formula (C), formula (D) or formula (E), lithium composite oxides having a spinel-type structure of formula (F), and lithium composite phosphates having an olivine-type structure of formula (G). Specific examples thereof include LiNi_{0.05}Co_{0.20}Mn_{0.30}O₂, LiCoO₂, LiNiO₂, LiNiaCo₁₋ₐO₂(0<a<1), and LiMn₂O₄ and LiFePO₄.

LiₚNi_{(1-q-r)}Mn_{q}M1ᵣO_{(2-y)}X_{z} (A)

(in formula (A), M1 represents at least one element selected from Groups 2 to 15 excluding Ni and Mn; X represents at least one selected from Group 16 elements other than oxygen, and Group 17 elements; and p, q, y, and z each represent a value within the ranges of 0≤p≤1.5, 0≤q≤1.0, 0≤r≤1.0, −0.10≤y≤0.20 and 0≤z≤0.2).

LiₐM2_{b}PO₄ (B)

(in formula (B), M2 represents at least one element selected from Groups 2 to 15; and a and b each represent a value within the range of 0≤a≤2.0 and 0.5≤b≤2.0).

Li_{f}Mn_{(1-g-h)}Ni_{g}M3ₕO₍₂₋ⱼ₎Fₖ (C)

(in formula (C), M3 represents at least one selected from the group consisting of Co, Mg, Al, B, Ti, V, Cr, Fe, Cu, Zn, Zr, Mo, Sn, Ca, Sr and W; and f, g, h, j and k each represent a value within the range of 0.8≤f≤1.2, 0<g<0.5, 0≤h≤0.5, g+h<1, −0.1≤j≤0.2 and 0≤k≤0.1, where the composition of lithium varies depending on a charge-discharge state, and the value of f represents a value in a complete discharge state).

LiₘNi₍₁₋ₙ₎M4ₙO₍₂₋ₚ₎F_{q} (D)

(in formula (D), M4 represents at least one selected from the group consisting of Co, Mn, Mg, Al, B, Ti, V, Cr, Fe, Cu, Zn, Mo, Sn, Ca, Sr and W; and m, n, p and q each represent a value within the range of 0.8≤m≤1.2, 0.005≤n≤0.5, −0.1≤p≤0.2 and 0≤q≤0.1, where the composition of lithium varies depending on a charge-discharge state, and the value of m represents a value in a complete discharge state).

LiᵣCo₍₁₋ₛ₎M5ₛO₍₂₋ₜ₎Fᵤ (E)

(in formula (E), M5 represents at least one selected from the group consisting of Ni, Mn, Mg, Al, B, Ti, V, Cr, Fe, Cu, Zn, Mo, Sn, Ca, Sr and W; and r, s, t and u are values within the range of 0.8≤r≤1.2, 0≤s≤0.5, −0.1≤t≤0.2 and 0≤u≤0.1, where the composition of lithium varies depending on a charge-discharge state, and the value of r represents a value in a complete discharge state).

LiᵥMn_{2-w}M6_{w}OₓF_{y} (F)

(in formula (F), M6 represents at least one selected from the group consisting of Co, Ni, Mg, Al, B, Ti, V, Cr, Fe, Cu, Zn, Mo, Sn, Ca, Sr and W; and v, w, x and y each represent a value within the range of 0.9≤v≤1.1, 0≤w≤0.6, 3.7≤x≤4.1 and 0≤y≤0.1,

where the composition of lithium varies depending on a charge-discharge state, and the value of v represents a value in a complete discharge state).

Li_{z}M7PO₄ (G)

(in formula (G), M7 represents at least one selected from the group consisting of Co, Mg, Fe, Ni, Al, B, Ti, V, Nb, Cu, Zn, Mo, Ca, Sr, W and Zr; and z represents a value within the range of 0.9≤z≤1.1, where the composition of lithium varies depending on a charge-discharge state, and the value of z represents a value in a complete discharge state).

As the positive active material capable of absorbing and releasing lithium, inorganic compounds free of lithium, such as MnO₂, V₂O₅, V₆O₁₃, NiS and MoS, in addition to the above-mentioned materials, can be used.

The positive active material capable of absorbing and releasing lithium may be one other than those described above. Two or more of the positive active materials shown above may be mixed in any combination.

The binder includes a fluorine-based binder having a melting point of 166° C. or lower. When the melting point of the fluorine-based binder is 166° C. or lower, the binder is easily melted during drying (heat treatment) of the positive active material layer 21B in the step of preparing the positive electrode 21, so that the surfaces of positive active material particles can be covered with a wide and thin binder film. This enables suppression of side reaction of a surface of the positive electrode 21 with the first additive contained in the electrolytic solution, i.e. consumption of the first additive in the positive electrode 21. Therefore, it is possible to effectively form a low-resistance film (SEI) on a surface of the negative electrode 22, which is the original purpose of the first additive, and to suppress an increase in resistance due to a side reaction on the surface of the positive electrode 21. Thus, it is possible to improve the discharge capacity in a low-temperature environment and charge-discharge cycle characteristics in a high temperature environment. Details of the first additive will be described later.

When the electrolytic solution further contains the second additive, and the melting point of the fluorine-based binder is 166° C. or lower, the consumption of the second additive during charge-discharge can be suppressed with the aid of a positive electrode protection function (function of suppressing side reaction between the second additive and the surface of the positive electrode) from the fluorine-based binder, and a film on a surface of the negative electrode formed from the first additive. This enables the second additive to be consumed little by little during a charge-discharge cycle, leading to lessening of film loss on the negative electrode 22. Therefore, the charge-discharge cycle characteristics in a high-temperature environment can be further improved. Details of the second additive will be described later. The lower limit of the melting point of the fluorine-based binder is not particularly limited, and is, for example, 152° C. or higher.

The melting point of the fluorine-based binder is measured in, for example, the following manner.

First, the positive electrode 21 is taken out from the battery, washed and dried with dimethyl carbonate (DMC), then the positive electrode current collector 21A is removed, and the mixture is heated and stirred in a suitable dispersion medium (e.g. N-methylpyrrolidone) to dissolve the binder in the dispersion medium. Thereafter, the positive active material is removed by centrifugation, the supernatant is filtered, and then evaporated to dryness or reprecipitated in water to take out the binder.

Next, a sample in an amount of several to several tens of mg is heated at a temperature rising rate of 1 to 10° C./min with a differential scanning calorimeter (DSC, e.g. Rigaku Thermoplus DSC8230 manufactured by Rigaku Corporation), and the temperature at an endothermic peak with the maximum heat absorption amount among endothermic peaks appearing in the temperature range of 100° C. to 250° C. is defined as the melting point of the fluorine-based binder (see FIG. 3).

The fluorine-based binder is, for example, polyvinylidene fluoride (PVdF). As the polyvinylidene fluoride, it is preferable to use a homopolymer containing vinylidene fluoride (VdF) as a monomer. As the polyvinylidene fluoride, a copolymer containing vinylidene fluoride (VdF) as a monomer can be used, but since polyvinylidene fluoride, which is a copolymer, easily swells and dissolves in an electrolytic solution, and has a low binding force, the characteristics of the positive electrode 21 may be deteriorated. As the polyvinylidene fluoride, one modified at a part thereof, such as an end thereof, with carboxylic acid such as maleic acid may be used.

The content of the fluorine-based binder in the positive active material layer 21B is 0.5 mass % or more and 2.8 mass % or less, preferably 0.7 mass % or more and 2.4 mass % or less, more preferably 1.0 mass % or more and 2.0 mass % or less. If the content of the fluorine-based binder is less than 0.5 mass %, the covering of the positive active material particles with the fluorine-based binder becomes insufficient, so that the first additive is consumed on a surface of the positive electrode 21, leading to insufficient formation of a low-resistance film on a surface of the negative electrode 22. Therefore, it is not possible to obtain a high discharge capacity in a low temperature environment, and it is not possible to obtain good charge-discharge cycle characteristics in a high temperature environment. On the other hand, if the content of the fluorine-based binder is more than 2.8 mass %, the positive active material particles are excessively covered with the fluorine-based binder, so that the internal resistance of the battery increases. Therefore, it is not possible to obtain a high discharge capacity in a low temperature environment, and it is not possible to obtain good charge-discharge cycle characteristics in a high temperature environment.

The content of the fluorine-based binder is measured in the following manner. First, the positive electrode 21 is taken out from the battery, washed with DMC, and dried. Next, a sample in an amount of several to several tens of mg is heated to 600° C. at a temperature rising rate of 1 to 5° C./min in an air atmosphere with a thermogravimetric-differential thermal analyzer (TG-DTA, e.g. Rigaku Thermoplus DSC8120 manufactured by Rigaku Corporation), and the content of the fluorine-based binder in the positive active material layer 21B is determined from the amount of weight loss here. Whether or not the amount of weight loss is caused by the binder is determined by isolating the binder as described in the above-mentioned method for measurement of a melting point of the binder described above, performing TG-DTA measurement of the binder alone in an air atmosphere, and examining the temperature at which the binder burns.

As the conductive agent, for example, at least one carbon material selected from the group consisting of graphite, carbon fiber, carbon black, Ketjen black, carbon nanotubes and the like is used. The conductive agent may be any material having conductivity, and is not limited to the carbon material. For example, a metallic material, a conductive polymer material or the like may be used as the conductive agent.

The negative electrode 22 includes, for example, a negative electrode current collector 22A and a negative active material layer 22B provided on both surfaces of the negative electrode current collector 22A. The negative electrode current collector 22A is formed of, for example, a metal foil such as a copper foil, a nickel foil or a stainless steel foil. The negative active material layer 22B contains one or more negative electrode active materials capable of absorbing and releasing lithium. The negative active material layer 22B may further contain at least one of a binder and a conductive agent if necessary.

In this battery, the electrochemical equivalent of the negative electrode 22 or the negative active material is larger than the electrochemical equivalent of the positive electrode 21, and theoretically, it is preferable that lithium metal does not precipitate on the negative electrode 22 during charge.

Examples of the negative active material include carbon materials such as hardly graphitizable carbon, easily graphitizable carbon, graphite, thermally decomposed carbons, cokes, glassy carbons, organic polymer compound fired products, carbon fiber and activated carbon. Of these, the cokes include pitch coke, needle coke and petroleum coke. The organic polymer compound fired product is a material obtained by firing a polymer material such as a phenol resin or a furan resin at an appropriate temperature into carbon, a part of which is classified as hardly graphitizable carbon or easily graphitizable carbon. Such carbon materials are preferable because a change in crystal structure generated during charge-discharge is very small, and it is possible to obtain a high charge-discharge capacity and good cycle characteristics. In particular, graphite is preferable because it has a large electrochemical equivalent, and a high energy density can be obtained. Graphitizable carbon is preferable because excellent cycle characteristics can be obtained.

Further, materials having a low charge-discharge potential, specifically materials having a charge-discharge potential close to that of lithium metal, are preferable because the energy density of the battery can be easily enhanced.

Examples of other negative active materials capable of enhancing the capacity include materials containing at least one of metal elements and semimetal elements as constituent elements (e.g. an alloy, a compound or a mixture). This is because when such a material is used, a high energy density can be obtained. In particular, it is preferable to use the negative active material together with a carbon material because it is possible to obtain high energy density and excellent cycle characteristics. In the present technology, the alloys include those including two or more metal elements, and those including one or more metal elements and one or more semimetal elements. The alloys may include nonmetal elements. Some of the structures thereof are solid solutions, eutectics (eutectic mixtures), intermetallic compounds, or materials in which two or more thereof coexist.

Examples of such negative active materials include metal elements and semimetal elements which are capable of forming an alloy with lithium. Specific examples include Mg, B, Al, Ti, Ga, In, Si, Ge, Sn, Pb, Bi, Cd, Ag, Zn, Hf, Zr, Y, Pd and Pt. These materials may be crystalline or amorphous.

The negative active material is preferably one containing a metal element or a semimetal element of Group 4B in the short periodic table as a constituent element, more preferably one containing at least one of Si and Sn as a constituent element. This is because Si and Sn have a high ability to absorb and release lithium, so that a high energy density can be obtained. Examples of such negative active materials include a simple substance of Si, or alloys or compounds thereof, a simple substance of Sn, or alloys or compounds thereof, and materials having one or more thereof at a part.

Examples of Si alloys include those containing at least one selected from the group consisting of Sn, Ni, Cu, Fe, Co, Mn, Zn, In, Ag, Ti, Ge, Bi, Sb, Nb, Mo, Al, P, Ga and Cr as second constituent elements other than Si. Examples of Sn alloys include those containing at least one selected from the group consisting of Si, Ni, Cu, Fe, Co, Mn, Zn, In, Ag, Ti, Ge, Bi, Sb, Nb, Mo, Al, P, Ga and Cr as second constituent elements other than Sn.

Examples of Sn compounds or Si compounds include those containing O or C as constituent elements. These compounds may contain the second constituent element.

In particular, the Sn-based negative active material is preferably one containing Co, Sn and C as constituent elements and having low crystallinity or an amorphous structure.

Examples of other negative active materials include metal oxides or polymer compounds capable of absorbing and releasing lithium. Examples of the metal oxide include lithium titanium oxide containing Li and Ti, such as lithium titanate (Li₄T₁₅O₁₂), iron oxide, ruthenium oxide and molybdenum oxide. Examples of the polymer compound include polyacetylene, polyaniline and polypyrrole.

As the binder, at least one selected from resin materials such as polyvinylidene fluoride (PVdF), polytetrafluoroethylene (PTFE), polyacrylonitrile (PAN), styrene butadiene rubber (SBR) and carboxymethyl cellulose (CMC), and copolymers mainly containing any of these resin materials as a main component is used.

As the conductive agent, the same material as that of the positive active material layer 21B can be used.

The separator 23 separates the positive electrode 21 and the negative electrode 22, and allows lithium ions to pass through the separator while preventing a short-circuit of current due to contact between the two electrodes. The separator 23 includes a porous film formed of polytetrafluoroethylene, polyolefin resin (polypropylene (PP), polyethylene (PE) or the like), acrylic resin, styrene resin, polyester resin or nylon resin, or a resin obtained by blending these resins, and may have a structure in which two or more of these porous films are laminated.

Of these, polyolefin porous films are preferable because they are excellent in short-circuit prevention effect, and enable improvement of safety of batteries by a shutdown effect. In particular, polyethylene is preferable as a material forming the separator 23 because polyethylene can exhibit a shutdown effect in the range of 100° C. or higher and 160° C. or lower, and is excellent in electrochemical stability. Of these, low-density polyethylene, high-density polyethylene and linear polyethylene are preferably used because such polyethylene has an appropriate melting temperature, and is easy to obtain. In addition, a material obtained by copolymerizing or blending a resin having chemical stability with polyethylene or polypropylene can be used. Alternatively, the porous film may have a structure of three or more layers in which a polypropylene layer, a polyethylene layer, and a polypropylene layer are laminated in this order. For example, it is desirable that the porous film have a three-layer structure, PP/PE/PP, in which the mass ratio of PP to PE is PP:PE=60:40 to 75:25.

Alternatively, from the viewpoint of cost, a single-layer substrate having 100 wt % PP or 100 wt % PE can be used. The method for preparing the separator 23 may be of either wet type or dry type.

As the separator 23, a nonwoven fabric may be used. As the fiber forming the nonwoven fabric, aramid fiber, glass fiber, polyolefin fiber, polyethylene terephthalate (PET) fiber, nylon fiber or the like can be used. Two or more of these fibers may be mixed to form a non-woven fabric.

The separator 23 may have a structure in which the separator includes a substrate, and a surface layer provided on one or both surfaces of the substrate. The surface layer includes inorganic particles having electric insulation quality, and a resin material binding inorganic particles to a surface of the substrate and binding inorganic particles. For example, this resin material may be fibrillated so as to have a three-dimensional network structure in which a plurality of fibrils are connected. The inorganic particles are supported on a resin material having the three-dimensional network structure.

The resin material may bind a surface of the substrate and inorganic particles rather than being fibrillated. In this case, a higher binding property can be obtained. By providing a surface layer on one or both surfaces of the substrate as described above, the oxidation resistance, the heat resistance and the mechanical strength of the separator 23 can be enhanced.

The substrate is a porous film which is permeable to lithium ions and is formed of an insulating film having predetermined mechanical strength. It is preferable that the substrate have high resistance to an electrolytic solution and low reactivity and hardly expand because the electrolytic solution is held in voids of the substrate.

As a material forming the substrate, the resin material or the nonwoven fabric forming the separator 23 can be used.

The inorganic particle includes at least one selected from the group consisting of metal oxides, metal nitrides, metal carbides, metal sulfides and the like. As the metal oxide, aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), yttrium oxide (yttria, Y₂O₃) or the like can be preferably used. As the metal nitride, silicon nitride (Si₃N₄), aluminum nitride (AlN), boron nitride (BN), titanium nitride (TiN) or the like can be used. As the metal carbide, silicon carbide (SiC), boron carbide (B₄C) or the like can be preferably used. As the metal sulfide, barium sulfate (BaSO₄) or the like can be preferably used. Of the above-described metal oxides, alumina, titania (particularly those having a rutile-type structure), silica or magnesia are preferably used, and alumina is more preferably used.

The inorganic particle may contain a mineral such as a porous aluminosilicate such as zeolite (M_{2/n}O.Al₂O₃.xSiO₂.yH₂O, where M is a metal element, x≥2, y≥0), a layered silicate, barium titanate (BaTiO₃) or strontium titanate (SrTiO₃). The inorganic particles have oxidation resistance and heat resistance, so that a surface layer on a lateral surface opposite to the positive electrode, which contains the inorganic particles, has strong resistance to an oxidizing environment in the vicinity of the positive electrode during charge. The shape of the inorganic particles is not particularly limited, and may have any of a spherical shape, plate shape, a fibrous shape, a cubic shape and a random shape.

The particle size of the inorganic particles is preferably in the range of 1 nm or more and 10 μm or less. This is because if the particle size is smaller than 1 nm, it is difficult to obtain the inorganic particles, and if the particle size is larger than 10 μm, the distance between electrodes increases, it is impossible to obtain a sufficient active material loading amount with a limited space, leading to a decrease in battery capacity.

Examples of the resin material forming the surface layer include fluorine-containing resins such as polyvinylidene fluoride and polytetrafluoroethylene; fluorine-containing rubbers such as vinylidene fluoride-tetrafluoroethylene copolymers and ethylene-tetrafluoroethylene copolymers; rubbers such as styrene-butadiene copolymers or hydrides thereof, acrylonitrile-butadiene copolymers or hydrides thereof, acrylonitrile-butadiene-styrene copolymers or hydrides thereof, methacrylic acid ester-acrylic acid ester copolymers, styrene-acrylic acid ester copolymers, acrylonitrile-acrylic acid ester copolymers, ethylene propylene rubber, polyvinyl alcohol and polyvinyl acetate; cellulose derivatives such as ethyl cellulose, methyl cellulose, hydroxyethyl cellulose and carboxymethyl cellulose; and resins whose melting point and/or glass transition temperature are 180° C. or higher, such as polyphenylene ether, polysulfone, polyether sulfone, polyphenylene sulfide, polyether imide, polyimide, polyamide such as totally aromatic polyamide (aramid), polyamideimide, polyacrylonitrile, polyvinyl alcohol, polyether, acrylic acid resins and polyester. One of these resin materials may be used alone, or two or more thereof may be used in combination. In particular, fluorine-based resins such as polyvinylidene fluoride are preferable from the viewpoint of oxidation resistance and flexibility, and it is preferable that the resin material contain aramid or polyamideimide.

As a method for forming a surface layer, for example, a method can be used in which a slurry formed of a matrix resin, a solvent and inorganic particles is applied onto a substrate (porous film), subjected to phase separation by passing through a baths containing a poor solvent for matrix resin and an affinity solvent for the poor solvent, and then dried.

The porous film as a substrate may contain the above-described inorganic particles. The surface layer may be free of inorganic particles, and formed only of a resin material.

The electrolytic solution as an electrolyte is a so-called nonaqueous electrolytic solution, which contains a nonaqueous solvent, an electrolyte salt and a first additive. Preferably, the electrolytic solution further contains a second additive. As the electrolyte, an electrolyte layer containing an electrolytic solution and a polymer compound serving as a holding material for holding the electrolytic solution may be used instead of the electrolytic solution. In this case, the electrolyte layer may be in the form of a gel.

Examples of the nonaqueous solvent include carbonate such as ethylene carbonate (EC), propylene carbonate (PC), butylene carbonate (BC), dimethyl carbonate (DMC), diethyl carbonate (DEC), ethylmethyl carbonate (EMC), carboxylic acid esters such as methyl acetate (MA), ethyl acetate (EA), propyl acetate (PA), butyl acetate (BA), methyl propionate (MP), ethyl propionate (EP), propyl propionate (PP), butyl propionate (BP), and lactons such as γ-butyrolactone and γ-valerolactone. One of these solvents may be used alone, or two or more thereof may be used in combination.

The electrolyte salt contains at least one of light metal salts such as lithium salts.

Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCFSO₃), lithium tetrachloroaluminate (LiAlCl₄), dilithium hexafluorosilicate (Li₂SiF₆), lithium chloride (LiCl) and lithium bromide (LiBr).

The first additive is reduced and decomposed on the surface of the negative electrode 22 to form a low-resistance film (Solid Electrolyte Interphase. SEI) on a surface of the negative electrode 22. The film formation enables improvement of the discharge capacity in a low-temperature environment and charge-discharge cycle characteristics in a high temperature environment.

The first additive is a cyclic ether of at least one of 1,3-dioxane and derivatives thereof. 1,3-dioxane and derivatives thereof are more reactive on the surface of the negative electrode 22 than the structural isomers of 1,3-dioxane (e.g. 1,4-dioxane) and derivatives thereof, so that film formation is easily performed. Therefore, 1,3-dioxane and derivatives thereof are more advantageous than the structural isomers of 1,3-dioxane and derivatives thereof in that the discharge capacity in a low-temperature environment and charge-discharge cycle characteristics in a high-temperature environment are improved.

The 1,3-dioxane derivative is preferably one represented by the following formula (1).

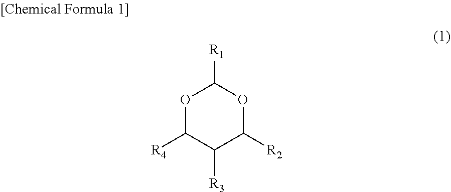

wherein R₁, R₂, R₃, and R₄ are each independently a saturated or unsaturated hydrocarbon group, a saturated or unsaturated hydrocarbon group having a halogen group, a halogen group, or a hydrogen group, except for cases where all of R₁, R₂, R₃, and R₄ are hydrogen groups.

The content of the first additive in the electrolytic solution is 0.1 mass % or more and 2 mass % or less, preferably 0.5 mass % or more and 2 mass % or less, more preferably 1.0 mass % or more and 1.5 mass % or less. If the content of the first additive is less than 0.1 mass %, the film formation from the first additive at the negative electrode 22 is insufficient, so that a sufficient effect of the first additive cannot be obtained. Therefore, it is not possible to obtain a high discharge capacity in a low temperature environment, and it is not possible to obtain good charge-discharge cycle characteristics in a high temperature environment. On the other hand, if the content of the first additive is more than 2 mass %, a film derived from the first additive is excessively formed, and thus the resistance increases, so that it is not possible to obtain a high discharge capacity in a low-temperature environment, and it is not possible to obtain good charge-discharge cycle characteristics in a high-temperature environment.

The content of the first additive is determined, for example, in the following manner. First, the battery is disassembled in an inert atmosphere of a glove box or the like, and an electrolytic solution component is extracted using DMC, a deuterated solvent or the like. Next, GC-MS (Gas Chromatograph-Mass Spectrometry) measurement and ICP (Inductively Coupled Plasma) measurement are performed on the resulting extract to determine the content of the first additive in the electrolytic solution.

The second additive is reduced and decomposed on a surface of the negative electrode 22 to form a low-resistance film on the surface of the negative electrode 22, and when the second additive is used in combination with the first additive, a film with lower resistance is formed as compared to a case where the first and second additives are added singly, and therefore a high discharge capacity can be obtained during low-temperature charge-discharge. The film formed on the surface of the negative electrode 22 is decomposed and gradually lost as the charge-discharge cycle is repeated, but the positive electrode protection function of the low melting point fluorine-based binder and the negative electrode protection function of the first additive suppress consumption of the second additive, so that the second additive is gradually consumed during the charge-discharge cycle to lessen film loss on the negative electrode 22. This enables further improvement of charge-discharge cycle characteristics in a high-temperature environment.

The second additive is at least one carbonate selected from fluoroethylene carbonate (FEC) and derivatives thereof. The FEC derivative is preferably one represented by the following formula (2).

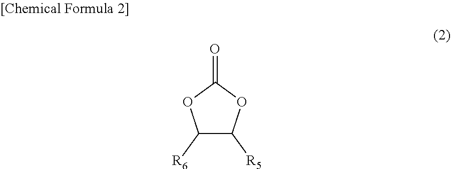

wherein R₅ and R₆ are each independently a saturated or unsaturated hydrocarbon group, a saturated or unsaturated hydrocarbon group having a halogen group, a halogen group, or a hydrogen group, except for cases where one of R₅ and R₆ is a hydrogen group, and the other is a fluorine group.

The content of the second additive in the electrolytic solution is preferably 0.05 mass % or more and 5 mass % or less, more preferably 0.1 mass % or more and 5 mass % or less, still more preferably 1 mass % or more and 5 mass % or less, especially preferably 2 mass % or more and 5 mass % or less. When the content of the second additive is 0.05 mass % or more, the effect of the second additive can be effectively exhibited. On the other hand, when the content of the second additive is 5 mass % or less, it is possible to suppress a decrease in high-temperature storage characteristics (e.g. battery swelling during high-temperature storage) due to side reaction at the positive electrode 21.

The content of the second additive is determined in the same manner as in the case of the content of the first additive.

As used herein, the term “hydrocarbon group” is a general term for a group formed of carbon (C) and hydrogen (H), which may be linear or branched with one or more side chains, or may be a ring. The “saturated hydrocarbon group” is an aliphatic hydrocarbon group having no carbon-carbon multiple bond. The “aliphatic hydrocarbon groups” also include alicyclic hydrocarbon groups having a ring. The “unsaturated hydrocarbon group” is an aliphatic hydrocarbon group having a carbon-carbon multiple bond (carbon-carbon double bond or carbon-carbon triple bond).

When the formula (1) includes a hydrocarbon group, the number of carbon atoms contained in the hydrocarbon group is preferably 1 or more and 5 or less, more preferably 3 or less. When the formula (2) includes a hydrocarbon group, the number of carbon atoms contained in the hydrocarbon group is preferably 1 or more and 5 or less, more preferably 3 or less.

When formulae (1) and (2) each include a halogen group, the halogen group is, for example, a fluorine group (—F), a chlorine group (—Cl), a bromine group (—Br) or an iodine group (—I), preferably a fluorine group (—F).

When the battery having the above-described configuration is charged, for example, lithium ions are released from the positive active material layer 21B, and absorbed into the negative active material layer 22B via the electrolytic solution. When the battery is discharged, for example, lithium ions are released from the negative active material layer 22B, and absorbed into the positive active material layer 21B via the electrolytic solution.

Next, an example of a method for producing a battery according to the first embodiment of the present technology will be described.

The positive electrode 21 is prepared in the following manner. First, for example, a positive active material, a conductive agent and a binder are mixed to prepare a positive mixture, and this positive mixture is dispersed in a solvent such as N-methyl-2-pyrrolidone (NMP) to prepare a paste-like positive mixture slurry. Next, this positive mixture slurry is applied to the positive electrode current collector 21A, the solvent is removed by drying, and the positive active material layer 21B is formed by compression molding with a roll press machine or the like to obtain the positive electrode 21.

The negative electrode 22 is prepared in the following manner. First, for example, a negative active material and a binder are mixed to prepare a negative mixture, and this negative mixture is dispersed in a solvent such as N-methyl-2-pyrrolidone to prepare a paste-like negative mixture slurry.

Next, this negative mixture slurry is applied to the negative electrode current collector 22A, the solvent is removed by drying, and the negative active material layer 22B is formed by compression molding with a roll press machine or the like to obtain the negative electrode 22.

A winding-type electrode body 20 is manufactured as follows. First, the positive electrode lead 11 is attached to one end of the positive electrode current collector 21A by welding, and the negative electrode lead 12 is attached to one end of the negative electrode current collector 22A by welding. Next, the positive electrode 21 and the negative electrode 22 are wound around a flat winding core with the separator 23 interposed therebetween, the laminate is wound multiple times in the longitudinal direction, and a protective tape 24 is bonded to the outermost peripheral portion to obtain the electrode body 20.

The electrode body 20 is encapsulated with the exterior material 10 in the following manner. First, the electrode body 20 is sandwiched between exterior materials 10, the exterior materials 10 are heat-sealed at the outer peripheral edge portion except for one side to form a bag, and the electrode body 20 is stored inside the exterior materials 10. At that time, the adhesion film 13 is inserted between the positive electrode lead 11 and negative electrode lead 12 and the exterior material 10. The adhesion film 13 may be attached to the positive electrode lead 11 and the negative electrode lead 12 in advance.

Next, the electrolytic solution is injected to the inside of the exterior materials 10 from the unsealed side, and the exterior materials are heat-sealed at the unsealed side in a vacuum atmosphere to hermetically seal the electrolytic solution. In this way, the battery shown in FIGS. 1 and 2 can be obtained.

The battery according to the first embodiment includes the positive electrode 21, the negative electrode 22, the separator 23, and an electrolytic solution. The positive electrode 21 has the positive active material layer 21B containing a fluorine-based binder having a melting point of 166° C. or lower, and the content of the fluorine-based binder in the positive active material layer 21B is 0.5 mass % or more and 2.8 mass % or less. The electrolytic solution contains at least one first additive selected from 1,3-dioxane and derivatives thereof, and the content of the first additive in the electrolytic solution is 0.1 mass % or more and 2 mass % or less. Accordingly, it is possible to obtain a high discharge capacity in a low temperature environment, and it is possible to obtain good charge-discharge cycle characteristics in a high temperature environment.

Patent Document 1 describes a lithium ion secondary battery obtained using a nonaqueous electrolytic solution containing 0.05 to 4 mass % of FEC and 0.001 to 0.5 mass % of cyclic ether, but does not describe use of a fluorine-based binder having a melting point of 166° C. or lower as a positive electrode binder. Therefore, in Patent Document 1, positive active material particles are not sufficiently covered with the binder, and thus the consumption of FEC and the cyclic ether at the positive electrode during charge-discharge increases. Thus, it is difficult to sufficiently improve discharge characteristics in a low-temperature environment and cycle characteristics in a high-temperature environment.

If as described above, positive active material particles are not sufficiently covered with the binder, and thus the consumption of the cyclic ether at the positive electrode during charge-discharge increases, an increase in resistance on the positive electrode surface due to side reaction expands. Thus, in Patent Document 1, the upper limit of the content of the cyclic ether is limited to 0.5 mass % or less. On the other hand, in the battery according to the first embodiment, the upper limit of the content of 1,3-dioxane which is a cyclic ether can be increased to 2 mass % because the positive active material is sufficiently covered with the binder, and thus the consumption of the cyclic ether at the positive electrode during charge-discharge can be suppressed.

In the second embodiment, the electronic device including the battery according to the first embodiment will be described.

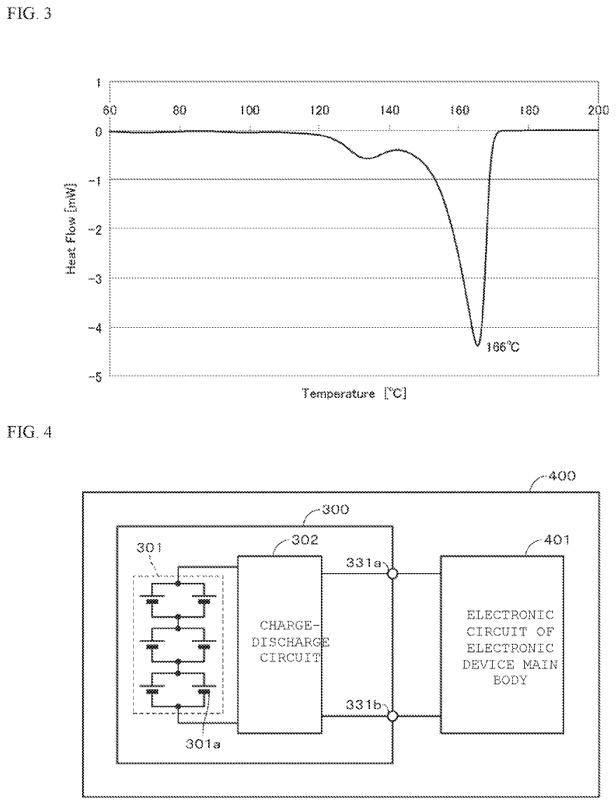

FIG. 4 shows an example of a configuration of an electronic device 400 according to the second embodiment of the present technology. The electronic device 400 includes an electronic circuit 401 of the electronic device main body and a battery pack 300. The battery pack 300 is electrically connected to an electronic circuit 401 via a positive electrode terminal 331a and a negative electrode terminal 331b. The electronic device 400 may have a configuration which enables the battery pack 300 to be detached.

Examples of the electronic device 400 include, but are not limited to, notebook personal computers, tablet computers, mobile phones (e.g. smartphones), personal digital assistants (PDAs), display devices (LCDs (liquid crystal displays), ELs (electro luminescence) displays, electronic papers and the like)), imaging devices (e.g. digital still cameras, digital video cameras and the like), audio equipment (e.g. portable audio players), game equipment, cordless phone handsets, electronic books, electronic dictionaries, radios, headphones, navigation systems, memory cards, pacemakers, hearing aids, power tools, electric shavers, refrigerators, air conditioners, TVs, stereos, water heaters, microwave ovens, dishwashers, washing machines, dryers, lighting equipment, toys, medical equipment, robots, road conditioners, and traffic lights.

The electronic circuit 401 includes, for example, a CPU (central processing unit), a peripheral logic unit, an interface unit, a storage unit and the like, and controls the entire electronic device 400.

The battery pack 300 includes an assembled battery 301 and a charge-discharge circuit 302. The battery pack 300 may further include an exterior material (not shown) that houses an assembled battery 301 and a charge-discharge circuit 302 if necessary.

The assembled battery 301 is formed by connecting a plurality of secondary batteries 301a in series and/or in parallel. A plurality of secondary batteries 301a are connected, for example, in parallel in n rows and in series in m lines (n and m are positive integers). FIG. 4 shows an example in which six secondary batteries 301a are connected in parallel in two rows and in series in three lines (2P3S). As the secondary battery 301a, the battery according to the first embodiment is used.

Here, the battery pack 300 including an assembled battery 301 including a plurality of secondary batteries 301a will be described, and a configuration may be employed in which the battery pack 300 includes one secondary battery 301a instead of the assembled battery 301.

The charge-discharge circuit 302 is a control unit that controls charge-discharge of the assembled battery 301. Specifically, during charge, the charge-discharge circuit 302 controls charge of the assembled battery 301. On the other hand, during discharge (during use of the electronic device 400), the charge-discharge circuit 302 controls discharge to the electronic device 400.

As the exterior material, for example, a case formed of a metal, a polymer resin, a composite material thereof or the like can be used. Examples of the composite material include a laminates in which a metal layer and a polymer resin layer are laminated.

### EXAMPLES

Hereinafter, the present technology will be described in detail with reference to examples, which should not be construed to limit the present technology.

The melting points of the fluorine-based binders in the following examples and comparative examples were determined by the measurement method described in the first embodiment described above.

### Example 1

A positive electrode was prepared in the following manner. 98.1 mass % of lithium cobalt composite oxide (LiCoO₂) as a positive active material, 1.4 mass % of PVdF (VdF homopolymer) having a melting point of 155° C. as a binder, and 0.5 mass % of carbon black as a conductive agent were mixed to obtain a positive mixture, and the positive mixture was then dispersed in an organic solvent (NMP) to obtain a paste-like positive mixture slurry. Subsequently, the positive mixture slurry was applied to the positive electrode current collector (aluminum foil) using a coating apparatus, and then dried to form a positive active material layer. In this drying step, the binder was melted, and the surfaces of positive active material particles were covered. Finally, the positive active material layer was compression-molded using a press machine until the mixture density was 4.0 g/cm³.

A negative electrode was prepared in the following manner. First, 96 mass % of artificial graphite powder as a negative active material, 1 mass % of SBR as a first binder, 2 mass % of PVdF as a second binder, and 1 mass % of CMC as a thickener were mixed to obtain a negative mixture, and the negative mixture was then dispersed in an organic solvent (NMP) to obtain a paste-like negative mixture slurry. Subsequently, the negative mixture slurry was applied to the negative electrode current collector (copper foil) using a coating apparatus, and then dried. Finally, the negative active material layer was compression-molded using a press machine.

An electrolytic solution was prepared in the following manner. First, EC and EMC were mixed at a mass ratio of 3:7 to prepare a mixed solvent. Subsequently, lithium hexafluorophosphate (LiPF₆) as an electrolyte salt was dissolved in this mixed solvent to a concentration of 1 mol/l to prepare an electrolytic solution. Next, 1,3-dioxane was added to the electrolytic solution with the amount of 1,3-dioxane adjusted so that the content of 1,3-dioxane in the electrolytic solution in a completed battery was 1 mass %.

A laminated battery was prepared in the following manner. First, an aluminum positive electrode lead was welded to the positive electrode current collector, and a copper negative electrode lead was welded to the negative electrode current collector. Subsequently, the positive electrode and the negative electrode were brought into close contact with each other with a microporous polyethylene film interposed therebetween, and then wound in a longitudinal direction, and a protective tape was bonded to the outermost peripheral portion to prepare a flat wound electrode body.

Next, this wound electrode body was inserted between exterior materials, the exterior materials were heat-sealed at three sides, while the exterior materials were not heat-sealed and had an opening at one side. As the exterior material, a moisture-proof aluminum laminate film was used in which a 25 μm-thick nylon film, a 40 μm-thick aluminum foil and a 30 μm-thick polypropylene film were laminated in this order from the outermost layer. Thereafter, the electrolytic solution was injected through the opening of the exterior materials, and the exterior materials were heat-sealed under reduced pressure at the unsealed side to hermetically seal the wound electrode body. In this way, an intended battery was obtained.

### Examples 2 to 6 and Comparative Examples 2 and 3

PVdF (a homopolymer of VdF) having a melting point of 166° C. was used as a binder. 1,3-dioxane was added to an electrolytic solution with the amount of 1,3-dioxane adjusted so that the content of 1,3-dioxane in the electrolytic solution in a completed battery was in the range of 0.05 to 2.5 mass % as shown in Table 1. Except for the above, the same procedure as in Example 1 was carried out to obtain a battery.

### Examples 7 to 12 and Comparative Examples 4 and 5

Except that 96.5 to 99.2 mass % of lithium cobalt composite oxide (LiCoO₂), 0.3 to 3.0 mass % of PVdF having a melting point of 165° C. as shown in Table 1, and 0.5 mass % of carbon black were mixed to obtain a positive mixture, the same procedure as in Example 2 was carried out to obtain a battery.

### Comparative Example 1

Except that PVdF (a homopolymer of VdF) having a melting point of 172° C. was used as a binder, the same procedure as in Example 1 was carried out to obtain a battery.

### Examples 13 to 20

Except that FEC was further added to an electrolytic solution with the amount of FEC adjusted so that the content of FEC in the electrolytic solution in a completed battery was in the range of 0.01 to 6.0 mass % as shown in Table 2, the same procedure as in Example 2 was carried out to obtain a battery.

### Examples 21 and 22 and Comparative Examples 6 and 7

Except that 1,3-dioxane was added to an electrolytic solution with the amount of 1,3-dioxane adjusted so that the content of 1,3-dioxane in the electrolytic solution in a completed battery was 0.05 mass %, 0.1 mass %, 2.0 mass % or 2.5 mass % as shown in Table 3, the same procedure as in Example 17 was carried out to obtain a battery.

### Comparative Examples 8 to 10

Except that instead of 1,3-dioxane, 1,4-dioxane was added to an electrolytic solution as shown in Table 3, the same procedure as in Examples 2 to 4 was carried out to obtain a battery.

### Comparative Examples 11 and 12

Except that FEC was further added to an electrolytic solution with the amount of FEC adjusted so that the content of FEC in the electrolytic solution in a completed battery was 2.0 mass % as shown in Table 3, and 1,4-dioxane was added to the electrolytic solution with the amount of 1,4-dioxane adjusted so that the content of 1,4-dioxane in the electrolytic solution in the completed battery was 1.5 mass % or 2.0 mass %¹ as shown in Table 3, the same procedure as in Comparative Example 8 was carried out to obtain a battery.

### Examples 23 and 24

Except that instead of FEC, DFEC (difluoroethylene carbonate) and FPC (fluoropropylene carbonate) were added to an electrolytic solution as shown in Table 4, the same procedure as in Example 17 was carried out to obtain a battery.

### Examples 25 to 27

Except that instead of 1,3-dioxane, 4-methyl-1,3-dioxane, 2,4-dimethyl-1,3-dioxane and 4-phenyl-1,3-dioxane were added to an electrolytic solution as shown in Table 4, the same procedure as in Example 2 was carried out to obtain a battery.

### Examples 28 to 30

Except that instead of 1,3-dioxane, 4-methyl-1,3-dioxane, 2,4-dimethyl-1,3-dioxane and 4-phenyl-1,3-dioxane were added to an electrolytic solution as shown in Table 4, the same procedure as in Example 17 was carried out to obtain a battery.

(Low-Temperature Discharge Capacity)

First, the battery was charged after being left standing in an environment at 23° C. until the temperature of the battery was stable. Thereafter, the battery was discharged to a final voltage of 3.0 V in an environment at 23° C., and the discharge capacity in an environment at 23° C. was measured. Subsequently, the battery was charged again in an environment at 23° C., and then left standing in an environment at −10° C. until the temperature was stable. Thereafter, the battery was discharged to a final voltage of 3.0 V in an environment at −10° C. under the same conditions for the discharge in an environment at 23° C., and the discharge capacity in an environment at −10° C. was measured. The low temperature discharge capacity (%) was determined from the following equation. For the charge-discharge rate, a capacity obtained by performing charge at 0.2 C and discharge at 0.2 C was used, where a current allowing the battery turn into a fully charged state from a discharged state in 1 hour is 1 C.

“Low temperature discharge capacity” (%)=(“discharge capacity in environment at −10° C.”/“discharge capacity in environment at 23° C.”)×100

(Capacity after High-Temperature Cycle)

First, the battery was charged after being left standing in an environment at 23° C. until the temperature of the battery was stable. Thereafter, the battery was discharged to a final voltage of 3.0 V in an environment at 23° C., and the discharge capacity in an environment at 23° C. was measured. Subsequently, the battery was left standing in an environment at 45° C., and then charged and discharged for 500 cycles in total. After being charged and discharged for 500 cycles, the battery was left standing in an environment at 23° C. again, and then charged. Thereafter, the battery was discharged to a final voltage of 3.0 V in an environment at 23° C., and the discharge capacity in an environment at 23° C. was measured. The capacity (%) after the high-temperature cycle was determined from the following equation. For the charge-discharge rate, a capacity obtained by performing charge at 0.5 C and discharge at 0.5 C was used, where a current allowing the battery turn into a fully charged state from a discharged state in 1 hour is 1 C.

“Capacity after high-temperature cycle” (%)=(“discharge capacity in environment at 23° C. after cycle”/“discharge capacity in environment at 23° C. before cycle”)×100

(Battery Thickness During High-Temperature Storage)

First, the thickness of the battery was measured after the battery was left standing in an environment at 23° C. until the temperature of the battery was stable. Subsequently, the battery was stored in an environment at 60° C. for a month. The thickness of the stored battery was measured after the battery was left standing in an environment at 23° C. until the temperature was stable. Then, the battery thickness (%) during high-temperature storage was determined from the following equation.

“Battery thickness during high-temperature storage” (%)=(“difference in battery thickness before and after high-temperature storage”/“battery thickness before high-temperature storage”)×100

Table 1 shows the configurations of batteries having different melting points of PVdF and different contents of PVdF or 1,3-dioxane, and the results of evaluation of the batteries.

TABLE 1

| | | | | | | | Battery |
|---|---|---|---|---|---|---|---|
| | | | | 1,3- | Low- | | thickness |
| | Binder | | | dioxane | temperature | Capacity | during |
| | Melting | Content | Solvent | content | discharge | after high- | high- |
| | point | [mass | (mass | [mass | capacity | temperature | temperature |
| | [° C.] | %] | ratio) | %] | [%] | cycle [%] | storage [%] |
| Example 1 | 155 | 1.4 | EC:EMC = | 1.0 | 83 | 83 | 4.2 |
| Example 2 | 166 | 1.4 | 3:7 | 1.0 | 85 | 84 | 4.1 |
| Example 3 | 166 | 1.4 | | 0.1 | 77 | 77 | 3.7 |
| Example 4 | 166 | 1.4 | | 0.5 | 79 | 80 | 3.8 |
| Example 5 | 166 | 1.4 | | 1.5 | 82 | 82 | 4.3 |
| Example 6 | 166 | 1.4 | | 2.0 | 80 | 81 | 4.8 |
| Example 7 | 166 | 0.5 | | 1.0 | 79 | 78 | 4.3 |
| Example 8 | 166 | 0.7 | | 1.0 | 82 | 82 | 4.0 |
| Example 9 | 166 | 1.0 | | 1.0 | 84 | 84 | 3.9 |
| Example 10 | 166 | 2.0 | | 1.0 | 83 | 84 | 3.8 |
| Example 11 | 166 | 2.4 | | 1.0 | 81 | 82 | 3.6 |
| Example 12 | 166 | 2.8 | | 1.0 | 79 | 79 | 3.8 |
| Comparative | 172 | 1.4 | | 1.0 | 65 | 64 | 4.2 |
| Example | | | | | | | |
| 1 | | | | | | | |
| Comparative | 166 | 1.4 | | 0.05 | 68 | 67 | 3.6 |
| Example | | | | | | | |
| 2 | | | | | | | |
| Comparative | 166 | 1.4 | | 2.5 | 70 | 71 | 4.0 |
| Example | | | | | | | |
| 3 | | | | | | | |
| Cornparative | 166 | 0.3 | | 1.0 | 64 | 63 | 8.0 |
| Example | | | | | | | |
| 4 | | | | | | | |
| Comparative | 166 | 3.0 | | 1.0 | 64 | 65 | 3.7 |
| Example | | | | | | | |
| 5 | | | | | | | |

Batteries obtained using PVdF having a melting point of 166° C. or lower and 1,3-dioxane exhibited a high low-temperature discharge capacity and a high capacity after high-temperature cycle (Examples 1 and 2). On the other hand, in batteries obtained using PVdF having a melting point higher than 166° C. and 1,3-dioxane, both the low-temperature discharge capacity and the capacity after high-temperature cycle were lower than those in Examples 1 and 2 (Comparative Example 1). The cause of the deterioration of the characteristics may be that in a positive electrode containing PVdF having a melting point higher than 166° C., positive active material particles are not sufficiently covered, and therefore 1,3-dioxane is decomposed in the vicinity of the positive electrode, so that an originally intended effect of film formation on the negative electrode cannot be sufficiently exhibited.

Further, in a battery obtained using PVdF having a melting point of 166° C. or lower and 1,3-dioxane, a high low-temperature discharge capacity and a high capacity after high-temperature cycle were obtained when the content of 1,3-dioxane in the electrolytic solution was within the range of 0.1 mass % or more and 2 mass % or less (Examples 2 to 6). On the other hand, when the content of 1,3-dioxane was outside the above-described range, the low-temperature discharge capacity and the capacity after high-temperature cycle decreased (Comparative Examples 2 and 3). The reason why the deterioration of the characteristics occurred may be as follows. If the content of 1,3-dioxane is less than 0.1 mass %, film formation from 1,3-dioxane at the negative electrode is insufficient, so that the effect of adding 1,3-dioxane cannot be sufficiently obtained. On the other hand, if the content of 1,3-dioxane is more than 2 mass %, a film derived from 1,3-dioxane is excessively formed, and resistance increases, so that the low-temperature discharge capacity and the capacity after high-temperature cycle decrease.

Further, in a battery obtained using PVdF having a melting point of 166° C. or lower and 1,3-dioxane, a high low-temperature discharge capacity and a high capacity after high-temperature cycle were obtained when the content of PVdF in the positive active material layer was 0.5 mass % or more and 2.8 mass % or less (Examples 2 and 7 to 12). On the other hand, when the content of PVdF was outside the above-described range, the low-temperature discharge capacity and the capacity after high-temperature cycle decreased (Comparative Examples 4 and 5).

The reason why the deterioration of the characteristics occurred may be as follows. If the content of PVdF is less than 0.5 mass %, the positive active material is not sufficiently covered with PVdF, and thus the effect of suppressing side reaction between 1,3-dioxane and the positive electrode cannot be sufficiently exhibited. On the other hand, if the content of PVdF is more than 2.8 mass %, the positive active material particles are excessively covered with PVdF, so that the resistance of the battery increases, leading to a decrease in low-temperature discharge capacity and capacity after high-temperature cycle.

Table 2 shows the configurations of batteries having FEC further added to the electrolytic solution and having different contents of FEC, and the results of evaluation of the batteries.

TABLE 2

| | | | | | | | | Battery |
|---|---|---|---|---|---|---|---|---|
| | | | | | 1,3- | Low- | | thickness |
| | Binder | | | FEC | dioxane | temperature | Capacity | during |
| | Melting | Content | Solvent | content | content | discharge | after high- | high- |
| | point | [mass | (mass | [mass | [mass | capacity | temperature | temperature |
| | [° C.] | %] | ratio) | %] | %] | [%] | cycle [%] | storage [%] |
| Example | 166 | 1.4 | EC:EMC = | 0.05 | 1.0 | 86 | 85 | 3.7 |
| 13 | | | 3:7 | | | | | |
| Example | | | | 1.0 | | 88 | 86 | 4.0 |
| 14 | | | | | | | | |
| Example | | | | 0.5 | | 89 | 87 | 4.1 |
| 15 | | | | | | | | |
| Example | | | | 1.0 | | 92 | 89 | 4.5 |
| 16 | | | | | | | | |
| Example | | | | 2.0 | | 93 | 91 | 4.6 |
| 17 | | | | | | | | |
| Example | | | | 5.0 | | 95 | 93 | 4.7 |
| 18 | | | | | | | | |
| Example | | | | 0.01 | | 85 | 84 | 3.7 |
| 19 | | | | | | | | |
| Example | | | | 6.0 | | 95 | 94 | 8.1 |
| 20 | | | | | | | | |

In batteries having FEC further added to the electrolytic solution as an additive in addition to 1,3-dioxane, a higher low-temperature discharge capacity and a higher capacity after high-temperature cycle were obtained as compared to batteries having only 1,3-dioxane added to the electrolytic solution as an additive (Examples 2 and 13 to 20). As the amount of FEC added increased, the low-temperature discharge capacity and the capacity after high-temperature cycle were improved, but the battery thickness during high-temperature storage tended to increase. By setting the FEC content to 5 mass % or less, it was possible to suppress a significant increase in battery thickness during high-temperature storage.

Table 3 shows the configurations of batteries including an electrolytic solution containing 1,3-dioxane or 1,4-dioxane as a structural isomer thereof, and the results of evaluation of the batteries.

TABLE 3

| | | | | | 1,3- | 1,4- | Low- | | Battery |
|---|---|---|---|---|---|---|---|---|---|
| | Binder | | | FEC | dioxane | dioxane | temperature | Capacity | thickness |
| | Melting | Content | Solvent | content | content | content | discharge | after high- | during high- |
| | point | [mass | (mass | [mass | [mass | [mass | capacity | temperaure | temperature |
| | [° C.] | %] | ratio) | %] | %] | %] | [%] | cycle [%] | storage [%] |
| Example 3 | 166 | 1.4 | EC:EMC = | — | 0.1 | — | 77 | 77 | 3.7 |
| Example 2 | | | 3:7 | — | 1.0 | — | 85 | 84 | 4.1 |
| Example 6 | | | | — | 2.0 | — | 80 | 81 | 4.8 |
| Example 21 | | | | 2.0 | 0.1 | — | 85 | 83 | 4.2 |
| Example 17 | | | | 2.0 | 1.0 | — | 93 | 91 | 4.6 |
| Example 22 | | | | 2.0 | 2.0 | — | 88 | 86 | 4.5 |
| Comparative | | | | 2.0 | 0.05 | — | 70 | 64 | 3.6 |
| Example 6 | | | | | | | | | |
| Comparative | | | | 2.0 | 2.5 | — | 64 | 66 | 4.5 |
| Example 7 | | | | | | | | | |
| Comparative | | | | — | — | 0.1 | 64 | 63 | 4.5 |
| Example 8 | | | | | | | | | |
| Comparative | | | | — | — | 0.5 | 65 | 64 | 4.1 |
| Example 9 | | | | | | | | | |
| Comparative | | | | — | — | 1.0 | 66 | 66 | 4.2 |
| Example 10 | | | | | | | | | |
| Comparative | | | | 2.0 | — | 1.5 | 72 | 71 | 4.3 |
| Example 11 | | | | | | | | | |
| Comparative | | | | 2.0 | — | 2.0 | 71 | 70 | 4.4 |
| Example 12 | | | | | | | | | |

Regardless of the content of the first additive (1,3-dioxane or 1,4-dioxane) and whether the second additive (FEC) is added or not, batteries obtained using 1,3-dioxane as the first additive exhibited a higher low-temperature discharge capacity and a higher capacity after high-temperature cycle as compared to batteries obtained using 1,4-dioxane as the first additive. This may be because 1,3-dioxane has higher reactivity on the negative electrode as compared to 1,4-dioxane, so that film formation is easily performed.

Table 4 shows the configurations of batteries having a 1,3-dioxane derivative contained in the electrolytic solution, or batteries having an FEC derivative contained in the electrolytic solution, and the results of evaluation of the batteries.

TABLE 4

| | | | | | | | | | | Battery |
|---|---|---|---|---|---|---|---|---|---|---|
| | | | | Halogenated | | | | Low- | | thickness |
| | Binder | | | carbonate | | Cyclic ether | | temperature | Capacity | during high- |
| | Melting | Content | Solvent | | Content | | Content | discharge | after high- | temperature |
| | point | [mass | (mass | | [mass | | [mass | capacity | temperature | storage |
| | [° C.] | %] | ratio) | Type | %] | Type | %] | [%] | cycle [%] | [%] |
| Example | 166 | 1.4 | EC:EMC = | FEC | 2.0 | 1,3- | 1.0 | 93 | 91 | 4.6 |
| 17 | | | 3:7 | | | dioxane | | | | |
| Example | | | | DFEC | 2.0 | 1,3- | | 88 | 88 | 4.6 |
| 23 | | | | | | dioxane | | | | |
| Example | | | | FEC | 2.0 | 1,3- | | 80 | 81 | 3.9 |
| 24 | | | | | | dioxane | | | | |
| Example | | | | — | — | 4- | | 85 | 84 | 4.0 |
| 25 | | | | | | Methyl- | | | | |
| | | | | | | 1,3- | | | | |
| | | | | | | dioxane | | | | |
| Example | | | | — | — | 2,4- | | 86 | 86 | 3.7 |
| 26 | | | | | | Dimethyl- | | | | |
| | | | | | | 1,3- | | | | |
| | | | | | | dioxane | | | | |
| Example | | | | — | — | 4- | | 80 | 87 | 3.8 |
| 27 | | | | | | Phenyl- | | | | |
| | | | | | | 1,3- | | | | |
| | | | | | | dioxane | | | | |
| Example | | | | FEC | 2.0 | 4- | | 90 | 91 | 4.2 |
| 28 | | | | | | Methyl | | | | |
| | | | | | | 1,3- | | | | |
| | | | | | | dioxane | | | | |
| Example | | | | FEC | 2.0 | 2,4- | | 89 | 90 | 4.3 |
| 29 | | | | | | Dimethyl- | | | | |
| | | | | | | 1,3- | | | | |
| | | | | | | dioxane | | | | |
| Example | | | | FEC | 2.0 | 4- | | 83 | 84 | 4.7 |
| 30 | | | | | | Phenyl- | | | | |
| | | | | | | 1,3- | | | | |
| | | | | | | dioxane | | | | |

In batteries having the 1,3-dioxane derivative or the FEC derivative contained in the electrolytic solution, both the low-temperature discharge capacity and the capacity after high-temperature cycle were 80/or more.

While the embodiments of the present technology have been described in detail, the present technology is not limited to the embodiments described above, and it is possible to make various modifications based on the technical concept of the present technology.

For example, the configurations, methods, steps, shapes, materials, numerical values and the like given in the embodiments are merely illustrative, and different configurations, methods, steps, shapes, materials, numerical values and the like may be used as necessary.

The configurations, methods, steps, shapes, materials, numerical values and the like of the embodiments can be combined without departing from the spirit of the present technology.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A nonaqueous electrolyte secondary battery comprising:
a positive electrode including a positive active material,
a negative electrode, and
an electrolytic solution, wherein
the positive active material layer includes a fluorine-based binder having a melting point of 166° C. or lower,
a content of the fluorine-based binder in the positive active material layer is from 0.5 mass % to 2.8 mass %,
the electrolytic solution includes at least a first additive selected from 1,3-dioxane and a 1,3-dioxane derivative, and a content of the first additive in the electrolytic solution is from 0.1 mass % to 2 mass %.

2. The nonaqueous electrolyte secondary battery according to claim 1, wherein the electrolytic solution further includes at least a second additive selected from fluoroethylene carbonate and a fluoroethylene carbonate derivative.

3. The nonaqueous electrolyte secondary battery according to claim 2, wherein the content of the second additive in the electrolytic solution is from 0.05 mass % to 5 mass %.

4. The nonaqueous electrolyte secondary battery according to claim 1, wherein the 1,3-dioxane derivative is represented by the chemical formula (1): 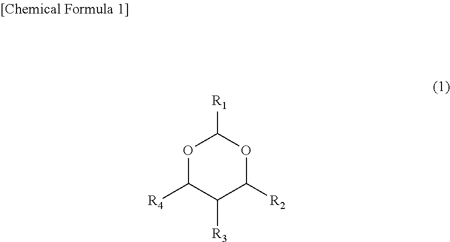
wherein R₁, R₂, R₃, and R₄ each independently represent a saturated or unsaturated hydrocarbon group, a saturated or unsaturated hydrocarbon group having a halogen group, a halogen group, or a hydrogen group, except for cases where all of R₁, R₂, R₃, and R₄ are hydrogen groups.

5. The nonaqueous electrolyte secondary battery according to claim 2, wherein the fluoroethylene carbonate derivative is represented by the chemical formula (2): 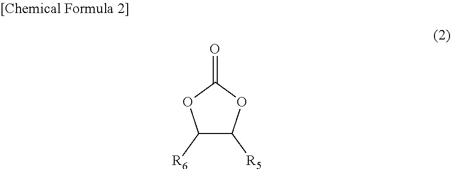
wherein R₅ and R₆ each independently represent a saturated or unsaturated hydrocarbon group, a saturated or unsaturated hydrocarbon group having a halogen group, a halogen group, or a hydrogen group, except for cases where one of R₅ and R₆ is a hydrogen group, and the other is a fluorine group.

6. The nonaqueous electrolyte secondary battery according to claim 1, wherein the content of the first additive in the electrolytic solution is from 1 mass % 2 mass %.

7. The nonaqueous electrolyte secondary battery according to claim 1 further comprising a separator, wherein the separator is provided between the positive electrode and the negative electrode.

8. The nonaqueous electrolyte secondary battery according to claim 7, wherein the separator includes a porous film.

9. The nonaqueous electrolyte secondary battery according to claim 1, wherein the positive electrode further includes a positive electrode current collector.

10. The nonaqueous electrolyte secondary battery according to claim 9, wherein the positive electrode current collector includes at least one of aluminum foil, nickel foil and a stainless steel foil.

11. An electronic device comprising:
a nonaqueous electrolyte secondary battery according to claim 1, and
an electronic circuit that is electrically connected to the secondary battery.
